(19) United States
(12) Patent Application Publication
(10) Pub. No.: US 2007/0245607 A1
(43) Pub. Date: Oct. 25, 2007

(54) SYSTEM AND METHODS FOR ILLUMINATING PANELS

(76) Inventors: George K. Awai, Danville, CA (US); Michael David Ernst, Alamo, CA (US)

Correspondence Address: KANG LIM, 3494 CAMINO TASSAJARA ROAD #436, DANVILLE, CA, 94306, US

(21) Appl. No.: 11/379,967

(22) Filed: Apr. 24, 2006

(51) Int. Cl. G09F 13/18

(52) U.S. Cl. 40/546

(57) ABSTRACT

A system for illuminating panels such as advertising display panels is provided. Such illuminated panels can be operated very efficiently, cost-effectively and with minimal maintenance once installed in the field. In one embodiment, the illuminated panel includes a panel frame with one or more illuminated frame member. Additional illuminated frame member(s) may be needed depending on the overall dimensions of the illuminated panel. The inside surface of the illuminated frame member should be reflective to increase the light transmission efficiency of the panel. A row of point light sources, e.g., a row of light emitting diodes, is located within the illuminated frame member. The panel frame encloses a light diffusion layer, e.g., an acrylic sheet, with a diffusion edge facing the row of point light sources. The diffusion edge has a surface roughness configured to diffuse light emitted by the row of point light sources. Suitable surface roughness can be accomplished by saw cuts or sanding the light diffusion layer with a suitable grit. In some embodiments, the illuminated frame member has an internal profile to better focus the light emitted by the light sources towards the diffusion edge. Suitable internal profiles include rounded profiles such as parabolic and elliptical shapes. Further, because the point light sources are discrete components, the panel frame members can take on a variety of shapes including curved shapes.

### BACKGROUND OF THE INVENTION

This invention relates generally to illuminating panels. More particularly, this invention relates to cost effective systems and methods for using multiple point light sources such as light emitting diodes (LEDs) to illuminate panels.

Illuminated panels have many uses where evenly lit panels with neutral color temperature are used including advertising display panels, shopping mall directories, restaurant menus, event schedules, and navigational signboards. Other uses for illuminated panels include light-boxes for artists, photographers, architects, design engineers, general contractors and draftsmen.

These illuminated panels can be as small as six inches by six inches, and as large as four feet by eight feet. Depending on their specific applications, weight, cost, panel thickness, and lamp-life, can all be crucial to the successful design, manufacture and marketing of these panels. In addition, environmental requirements such as vibration/shock resistance, impact resistance, operating temperature range, ease of maintenance and power consumption can also be important.

Florescent light tubes are used in most commercially available illuminated displays because of the inherent evenness of light output due to the tube's physical configuration. In addition, florescent lamp-life is significantly longer than incandescent bulbs, and florescent lights also consume significantly less power for the same light output.

While florescent tubes are better than incandescent bulbs for illuminating panels, they also have many disadvantages including overall size and weight of the power supply, and fragility of the glass tube. For example, because most illuminated panels are less than one-half of an inch thick, the florescent tubes have to be equally skinny and very fragile. Accordingly, the florescent tubes are easily damaged during manufacture, transportation and installation.

In addition, although florescent tubes have longer lamp-life than incandescent bulbs, florescent tubes have a tendency to flicker depending on the frequency of the driving voltage. The light output of florescent tubes is also not easily adjusted to match ambient light conditions. Ballasts are also required for operation of the fluorescent tubes. Florescent tubes are also inefficient when operated under low ambient temperatures.

There are also other disadvantages inherent with using single light sources, the most common of which are florescent tubes. Since florescent tubes are easily damaged when subjected to shock, when the single florescent tube fails, an entire side of the panel is not longer illuminated.

Previous attempts at replacing florescent tubes with point lights sources have failed because point light sources produce a “saw-tooth” effect in the light pattern. It is therefore apparent that an urgent need exists for an improved illuminator using point light sources for panels that is easy to manufacturer, easy to maintain, shock resistant, impact resistant, portable, cost effective, and have long lamp-life.

### SUMMARY OF THE INVENTION

To achieve the foregoing and in accordance with the present invention, systems and methods for illuminating panels such as advertising display panels are provided. Such illuminators can be operated very efficiently, cost-effectively and with minimal maintenance once installed in the field.

In one embodiment of the invention, the illuminated panel includes a panel frame with one or more illuminated frame member. Additional illuminated frame member(s) may be needed depending on the overall dimensions of the illuminated panel. The inside surface of the illuminated frame member should be reflective to increase the light transmission efficiency of the panel.

A row of point light sources, e.g., a row of light emitting diodes, is located within the illuminated frame member. The panel frame encloses a light diffusion layer, e.g., an acrylic sheet, with a diffusion edge facing the row of point light sources. The diffusion edge has a surface roughness configured to diffuse light emitted by the row of point light sources. Suitable surface roughness can be accomplished by saw cuts or sanding the light diffusion layer with a suitable grit.

In some embodiments, the illuminated frame member has an internal profile to better focus the light emitted by the light sources towards the diffusion edge. Suitable internal profiles include rounded profiles such as parabolic and elliptical shapes. Further, because the point light sources are discrete components, the panel frame members can take on a variety of shapes including curved shapes.

These and other features of the present invention will be described in more detail below in the detailed description of the invention and in conjunction with the following figures.

### BRIEF DESCRIPTION OF THE DRAWINGS

In order that the present invention may be more clearly ascertained, one embodiment will now be described, by way of example, with reference to the accompanying drawings, in which:

FIG. 1A is a front view of one embodiment of the present invention;

FIG. 1B is a cross-sectional view 1B-1B of FIG. 1A;

FIG. 1C is a cross-sectional view of a variant of the embodiment of FIG. 1;

FIG. 2 is a front view of another variant of the embodiment of FIG. 1; and

FIG. 3 is a front view of yet another variant of the embodiment of FIG. 1.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

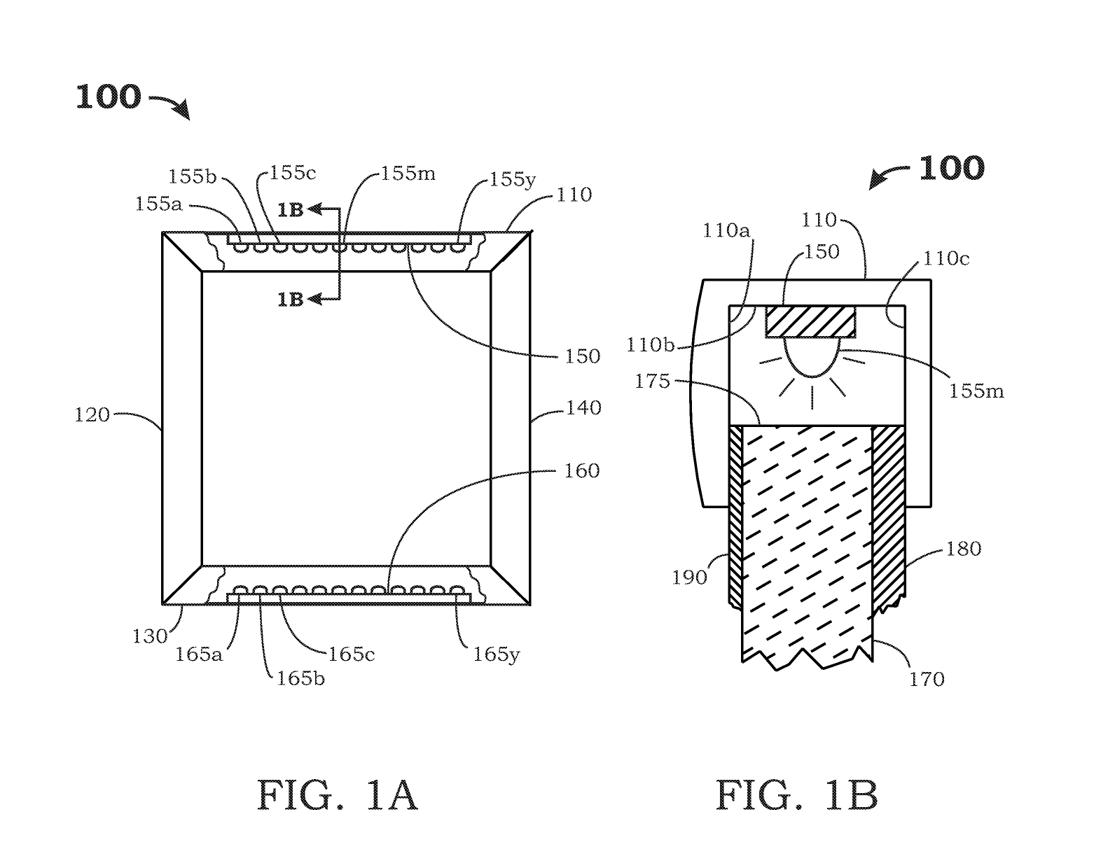

FIG. 1A is a front view showing one embodiment of an illuminated panel 100 in accordance with the present invention. Panel 100 includes frame members 110, 120, 130, 140. To facilitate discussion, the front portion of top frame member 110 and the front portion of bottom frame member 130 have cutaways exposing a top row of point light sources 155a, 155b, 155c . . . 155y and a bottom row of point light sources 165a, 165b, 165c . . . 165y, respectively.

The top row of point light sources 155a, 155b, 155c . . . 155y are mounted a light base 150 which functions as a mounting support and also as means for providing power and control to light sources 155a, 155b, 155c . . . 155y. Similarly, the bottom row of point light sources 165a, 165b, 165c . . . 165y are mounted a light base 160 which functions as a mounting support and also as means for providing power and control to light sources 165a, 165b, 165c . . . 165y. Depending on the overall panel dimensions and cost, weight, and/or power constraints of panel 100, one member, two members (as shown in this example), three members or all four members of frame members 110, 120, 130, 140 can be illuminated. In addition, power and control circuitry for panel 100 can either be internal, external, or combinations thereof, with respect to frame members 110, 120, 130, 140.

In this embodiment, point light sources 155a, 155b, 155c . . . 155y and 165a, 165b, 165c . . . 165y can be low-wattage light emitting diodes (LEDs) commercially available from www.nichia.com or www.cree.com. LEDs 155a, 155b, 155c . . . 155y and 165a, 165b, 165c . . . 165y are spaced about one-quarter of an inch apart from each other, resulting in about forty-eight LEDs per linear foot of light bases 150, 160, respectively. Each LED consumes about 20 mA and emits about 5 candela of visible light. LEDs 155a, 155b, 155c . . . 155y and 165a, 165b, 165c . . . 165y can be powered and controlled using commercially available constant-current power supplies, e.g., M/W model number TSU 66A-3 which provides 12V DC @ 5.5 A, or MWS model number 122500UC which provides 12V DC @ 250 mA. Another manufacturer of DC power supplies is XP Power (www.xpple.com).

FIG. 1B is a cross-sectional view 1B-1B of panel 100 showing top frame member 110, light source 155m attached to light base 150, and an illuminated display comprising a transparency 190, a diffusion layer 170 and a back-scattering layer 180. Transparency 190 can be merely in contact with diffusion layer 170 so that transparency 190 can be easily replaced by a new or different transparency. Alternatively, transparency 190 can be permanently attached to diffusion layer 170 using a suitable adhesive or process.

Diffusion layer 170 can be made from acrylic or another suitable plastic or polymer with the required light transmitting properties available from Mitsubishi. Back-scattering layer 180 can be made from a suitable highly reflective polymer such as Styrene or vinyl, available from 3M Corporation. Back-scattering layer 180 can either in contact with diffusion layer 170, or back-scattering layer 180 can be permanently bonded to diffusion layer 170 by a suitable adhesive.

The internal reflective characteristics of the frame members of panel 100 can be enhanced by incorporating a suitable frame profile thereby increasing the effectiveness of the illumination produced by LED 155m. For example, as shown in FIG. 1C, frame member 111 has parabolic surfaces 111d, 111e to better focus the light from LED 155m into diffusion layer 170.

The internal reflective characteristics of frame member 110 and frame member 111 can be further enhanced by incorporating a suitable surface polish to inner surfaces 110a, 110b, 110c and surfaces 111d, 111e, respectively. It is also possible to apply a reflective layer in the form of coating or chemical processing including painting, electro-plating or anodizing to the inner surfaces 110a, 110b, 110c, 111d, 111e. Light base 150 can be recessed into frame member 111 to better position LED 155m relative to parabolic surfaces 111d, 111e so that more light can be reflected into diffusion layer 170.

In order to minimize the saw-tooth problem due to the increased LED spacing, surface 175 of diffusion layer 170 has a surface roughness designed to diffuse the light emitted by LEDs 155a, 155b, 155c . . . 155y as the light enters diffusion layer 170. Since diffusion layer 170 can be cut to the appropriate size using several well known techniques such as band saws and circular saws, by leaving surface 175 unpolished with saw cut marks intact or by sanding using grit #2000 or lower, ensuring that the light entering diffusion layer 170 is sufficiently diffused to mitigate the saw-tooth problem.

Other modifications to the illuminated panels of the present invention are also possible. For example, the front portion of frame member 110 can be hinged so that transparency 190 can be easily replaced and also to provide easy access to light sources 155a, 155b, 155c . . . 155y.

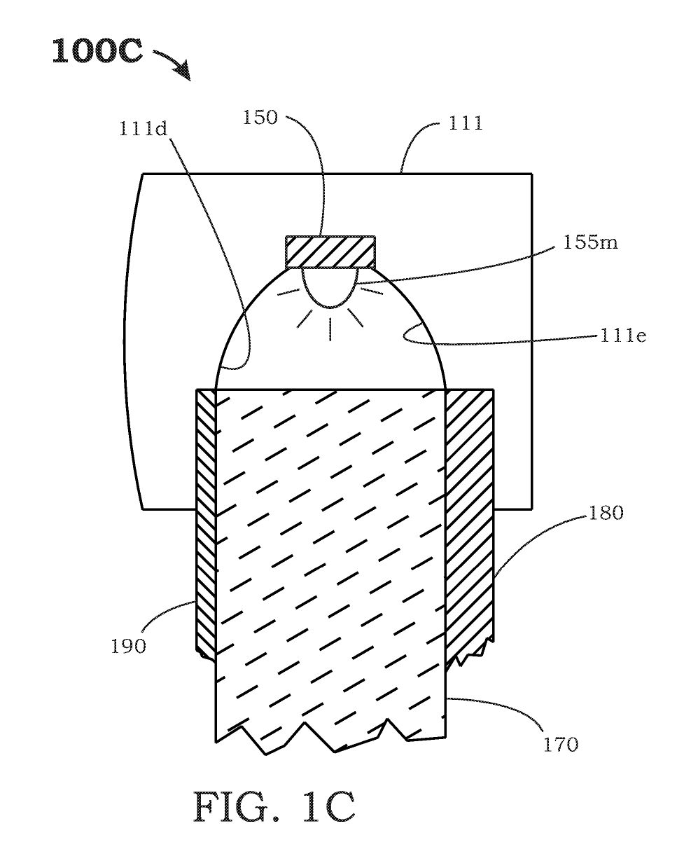

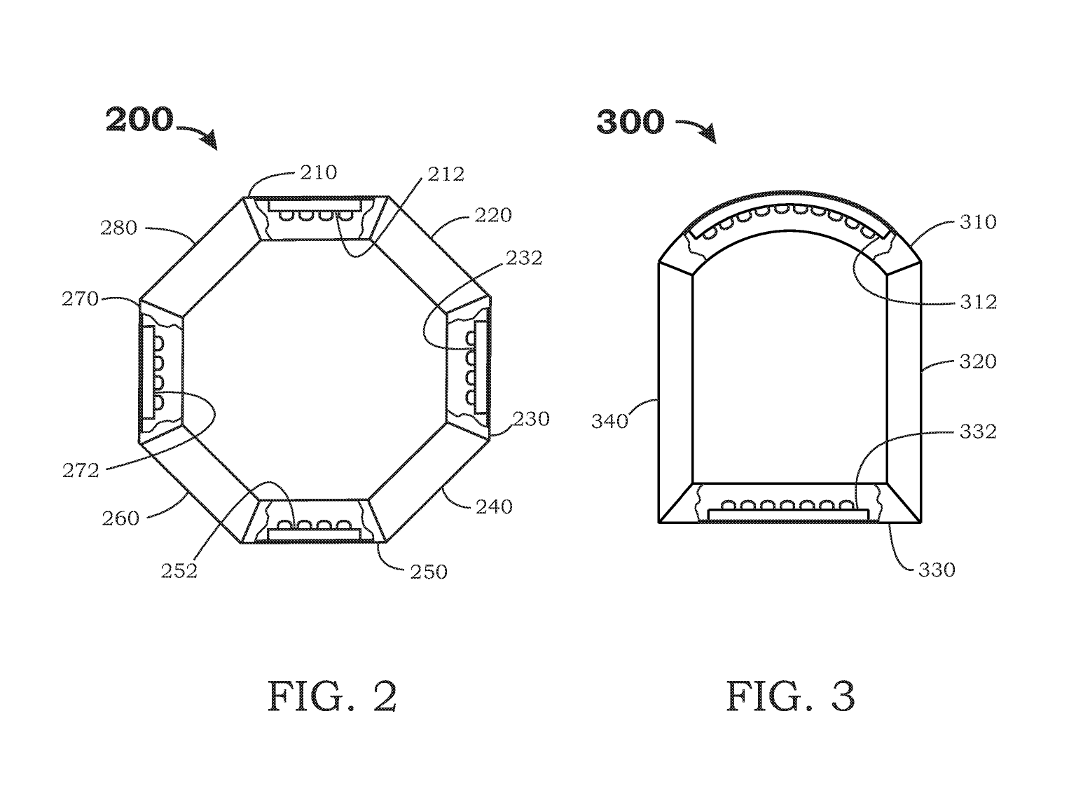

Another advantage of using point light sources is the increased variety of potential panel shapes. FIG. 2 is a cutaway front view of an octagonal panel 200 which includes frame members 210, 220, 230, 240, 250, 260, 270, 280, and light bases 212, 232, 252, 272 inside frame members 210, 230, 250, 270, respectively. Similarly, the cutaway front view of FIG. 3 illustrates a semi-circular panel 300 having a curved frame member 310 with curved light base 312, straight frame member 320, straight frame member 330 with straight light base 332, and straight frame member 340.

In the above described embodiments, frame members of panels 100, 200, 300, 400 and 500 can be manufactured from aluminum extrusions. The use of any other suitable rigid framing materials including other metals, alloys, plastics and composites such as steel, bronze, wood, polycarbonate, carbon-fiber, and fiberglass is also possible.

In sum, the present invention provides an improved illuminator using point light sources such as LEDs for illuminating panels that is easy to manufacturer, easy to maintain, shock resistant, impact resistant, portable, cost effective, and have long lamp-life, while minimizing the “saw-tooth” effect in the emitted light pattern.

While the present invention has been described with reference to particular embodiments, it will be understood that the embodiments are illustrative and that the inventive scope is not so limited. In addition, the various features of the present invention can be practiced alone or in combination. Alternative embodiments of the present invention will also become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. An illuminated panel comprising:
a panel frame having at least one illuminated frame member;
at least one row of point light sources located substantially within the at least one illuminated frame member; and
a diffusion layer have a diffusion edge facing the at least one row of point light sources, and wherein the diffusion edge has a surface roughness configured to diffuse light emitted by the at least one row of point light sources.

2. The illuminated panel of claim 1 wherein the surface roughness is caused by saw cuts.

3. The illuminated panel of claim 1 wherein the point light sources are light emitting diodes.

4. The illuminated panel of claim 1 wherein the at least one illuminated frame member has an internal profile configured to reflect light towards the diffusion edge of the diffusion layer.

5. The illuminated panel of claim 4 wherein the internal profile of the at least one illuminated frame member is parabolic.

6. The illuminated panel of claim 1 wherein the at least one illuminated frame member is curved and the at least one row of point light sources is also curved.
